(19) United States
(12) Patent Application Publication
(10) Pub. No.: US 2025/0067397 A1
(43) Pub. Date: Feb. 27, 2025

(54) HYDROGEN SUPPLY DEVICE OF FUEL CELL VEHICLE AND METHOD OF CONTROLLING SAME

(71) Applicant: ILJIN HYSOLUS CO., LTD., Jeollabuk-do (KR)

(72) Inventors: Jun Young Yim, Jeollabuk-do (KR); Seok Jin LEE, Jeollabuk-do (KR)

(21) Appl. No.: 18/723,742

(22) PCT Filed: Dec. 13, 2022
(86) PCT No.: PCT/KR2022/020179

§ 371 Date: Jun. 24, 2024

(30) Foreign Application Priority Data
Dec. 23, 2021 (KR) 10-2021-0186070

(51) Int. Cl. F17C 5/00; H01M 8/04082

(52) U.S. Cl. CPC F17C 5/007; H01M 8/04201; F17C 2205/0146; F17C 2205/0323; F17C 2205/0338; F17C 2221/012; F17C 2250/03; F17C 2250/043; F17C 2265/065; F17C 2270/0168; F17C 2270/0184; H01M 2250/20

(57) ABSTRACT

The present invention relates to a hydrogen supply device of a fuel cell vehicle and a method of controlling same, the device comprising: container valves which are respectively mounted to a plurality of hydrogen containers and supply and block hydrogen; a manifold which is connected to the plurality of hydrogen containers by a supply pipe; a regulator which is connected to the manifold, and supplies the high-pressure hydrogen at a reduced pressure required for a fuel cell; a supply valve which is installed on the supply pipe between the manifold and the regulator, and regulates hydrogen supply; a pressure sensor which senses the pressure of the manifold; and a control unit which supplies hydrogen by actuating the container valves and the supply valve after performing an initial operation sequence when a start-on signal is input from a peripheral control device.

### TECHNICAL FIELD

The present invention relates to a hydrogen supply device for a fuel cell vehicle and a method of controlling the same, and more specifically, to initial drive stabilization upon starting a fuel cell vehicle.

### BACKGROUND ART

In general, a fuel cell system applied to a hydrogen fuel cell vehicle, which is one eco-friendly future vehicle, is a device for generating electrical energy by chemically reacting oxygen in the air with externally supplied hydrogen.

Such a fuel cell system includes a fuel cell stack for generating electrical energy from the electrochemical reaction of reaction gases, a hydrogen supply device for supplying hydrogen as a fuel to the fuel cell stack, an air supply device for supplying air containing oxygen that is an oxidizing agent necessary for the electrochemical reaction in the fuel cell stack, a heat and water management system for emitting heat, which is a by-product of the electrochemical reaction of the fuel cell stack, to the outside to optimally control an operating temperature of the fuel cell stack and performing a water management function, and a fuel cell system controller for controlling an overall operation of the fuel cell system.

In general, the hydrogen supply device adjusts a pressure of high-pressure hydrogen in a hydrogen vessel in two stages while the high-pressure hydrogen passes through a high-pressure regulator and a low-pressure regulator and then supplies the adjusted high-pressure hydrogen to the fuel cell stack (anode). For example, high-pressure hydrogen of 350 bar or 700 bar supplied from the hydrogen vessel flows into the low-pressure regulator at a pressure of about 6 to 20 bar through the high-pressure regulator, the pressure is lowered to about 0.1 to 1 bar in the low-pressure regulator, and hydrogen of the lowered pressure is supplied to the fuel cell stack.

The background technology of the present invention is disclosed in Korean Patent No. 10-1113652 (published on Sep. 15, 2012 and entitled “HYDROGEN SUPPLY METHOD FOR FUEL CELL SYSTEM”).

### DISCLOSURE

### Technical Problem

When a vehicle turns on and a system initially starts, such a hydrogen supply device supplies hydrogen to a fuel cell by opening a valve of a hydrogen vessel without a separate waiting time.

In this case, in the case of a plurality of hydrogen vessels of the hydrogen supply device, although a temperature difference between vessels occurs according to vehicle conditions and a location of the hydrogen vessel when a hydrogen fuel cell vehicle travels actually, the same pressure is generated based one the temperature difference.

However, when the traveling is ended, the valve of the hydrogen vessel is closed and thus hydrogen in each vessel may not move. Therefore, when the hydrogen supply device is not operated for a long time, constant temperatures of the vessels are maintained, but pressures of the vessels are differently set according to a temperature deviation.

Upon receiving a start-on signal in a state in which the pressures of the vessels are differently set as described above, the hydrogen supply device supplies hydrogen by opening the vessel valve, and at this time, there is a problem that hydrogen is charged from a high-pressure vessel to a low-pressure vessel when the pressure difference between the vessels is great, or when an excess flow valve (EFV) of the vessel valve is operated, supply failure of hydrogen supplied to the fuel cell occurs, resulting in a problem in traveling.

The present invention has been made in efforts to solve the above problems and is intended to provide a hydrogen supply device for a fuel cell vehicle, which detects and stabilizes a pressure change caused by a pressure difference between vessels by performing an initial driving sequence upon starting a fuel cell vehicle and then supplies hydrogen to a fuel cell, and a method of controlling the same.

### Technical Solution

A hydrogen supply device for a fuel cell vehicle according to one aspect of the present invention includes a vessel valve mounted on each of a plurality of hydrogen vessels to supply and block hydrogen, a manifold connected to the plurality of hydrogen vessels through a supply pipe, a regulator connected to the manifold to lower a high pressure of hydrogen to a pressure required for a fuel cell and supply the hydrogen of the lowered pressure, a supply valve installed on the supply pipe between the manifold and the regulator to control hydrogen supply, a pressure sensor configured to detect a pressure of the manifold, and a controller configured to perform an initial driving sequence when a vehicle starts and then supply hydrogen by operating the vessel valve and the supply valve.

In the present invention, the controller may perform the initial driving sequence that repeatedly turns the vessel valve on and off for a first set time in an off state of the supply valve, then detect a change in pressure in the manifold through the pressure sensor, and when not detecting a change to a pressure that is a predetermined pressure or higher, supply hydrogen by operating the vessel valve and the supply valve.

In the present invention, the controller may detect the change in pressure in the manifold, when detecting the change to the pressure that is the predetermined pressure or higher, detect the change in pressure in the manifold after repeating the initial driving sequence, and supply hydrogen by operating the vessel valve and the supply valve.

In the present invention, when a start on signal is received and then a second set time has elapsed, the controller may supply hydrogen by operating the vessel valve and the supply valve.

In the present invention, when hydrogen is supplied by operating the vessel valve and the supply valve, the controller may output a supply signal to a peripheral control device.

A method of controlling a hydrogen supply device for a fuel cell vehicle according to another aspect of the present invention includes performing, by a controller, an initial driving sequence upon receiving a start on signal from a peripheral control device, detecting, by the controller, a change in pressure in a manifold after performing the initial driving sequence, when the controller detects the change in pressure in the manifold and the pressure is changed to a predetermined pressure or higher, returning to the performing of the initial driving sequence, and when the controller detects the change in pressure in the manifold and the pressure is not changed to the predetermined pressure or higher, supplying hydrogen by operating a vessel valve and a supply valve.

In the present invention, the performing of the initial driving sequence may include repeatedly turning, by the controller, the vessel valve on and off for a first set time in an off state of the supply valve.

In the present invention, the returning to the performing of the initial driving sequence may further include supplying, by the controller, hydrogen by operating the vessel valve and the supply valve when a second set time has elapsed after receiving the start on signal.

The method according to the present invention further includes outputting, by the controller, a supply signal to the peripheral control device when hydrogen is supplied by operating the vessel valve and the supply valve.

### Advantageous Effects

According to a hydrogen supply device for a fuel cell vehicle and a method of controlling the same according to one aspect of the present invention, by detecting and stabilizing a pressure change caused by a pressure difference between vessels by performing an initial driving sequence upon starting a fuel cell vehicle and then supplies hydrogen to a fuel cell, it is possible to prevent lack of a flow rate and a pressure drop phenomenon due to the pressure difference upon starting and stably start the fuel cell vehicle.

### DESCRIPTION OF DRAWINGS

FIG. 1 is a block configuration diagram showing a hydrogen supply device for a fuel cell vehicle according to one embodiment of the present invention.

FIG. 2 is an overall configuration diagram of the hydrogen supply device for a fuel cell vehicle according to one embodiment of the present invention.

FIG. 3 is a flowchart for describing a method of controlling the hydrogen supply device for a fuel cell vehicle according to one embodiment of the present invention.

### MODES OF THE INVENTION

Hereinafter, a hydrogen supply device for a fuel cell vehicle and a method of controlling the same according to the present invention will be described with reference to the accompanying drawings. In this process, thicknesses of lines, sizes of components, or the like illustrated in the drawings may be exaggerated for clarity and convenience of description. In addition, terms to be described below are the terms defined in consideration of functions in the present invention, which may be changed according to a user or operator's intention or custom. Therefore, the definition of these terms should be made based on the contents throughout the specification.

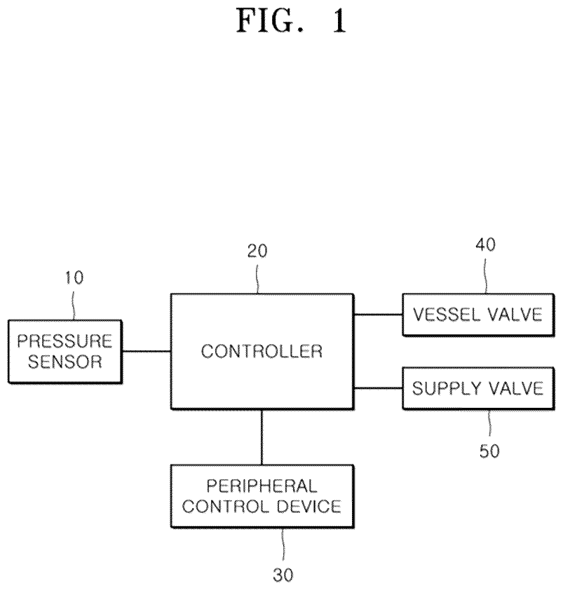

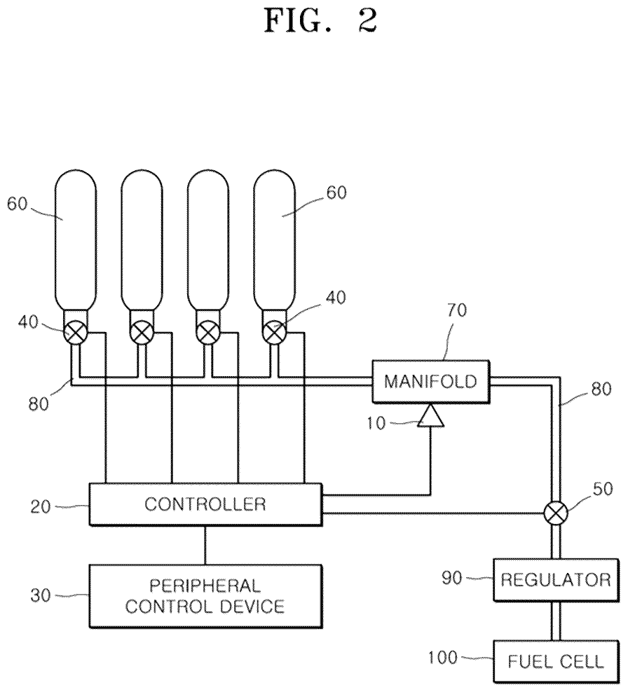

FIG. 1 is a block configuration diagram showing a hydrogen supply device for a fuel cell vehicle according to one embodiment of the present invention, and FIG. 2 is an overall configuration diagram of the hydrogen supply device for a fuel cell vehicle according to one embodiment of the present invention.

As shown in FIGS. 1 and 2, the hydrogen supply device for a fuel cell vehicle according to one embodiment of the present invention may include a vessel valve 40, a manifold 70, a regulator 90, a supply valve 50, a pressure sensor 10, and a controller 20.

The vessel valve 40 may be mounted on each of a plurality of hydrogen vessels 60 to supply and block hydrogen.

The manifold 70 may be connected to the plurality of hydrogen vessels 60 and a supply pipe 80 to supply hydrogen to one supply pipe 80.

The regulator 90 may be connected to the manifold 70 to lower a high pressure of hydrogen to a pressure required for a fuel cell 100 and supply hydrogen of the lowered pressure.

For example, a high pressure of 350 bar or 700 bar of hydrogen supplied from the hydrogen vessel 60 may be lowered to a pressure of about 0.1 to 1 bar, and hydrogen of the lowered pressure is supplied to the stack of the fuel cell 100.

The supply valve 50 may be installed on the supply pipe 80 between the manifold 70 and the regulator 90 to control hydrogen supply while performing an initial driving sequence.

The pressure sensor 10 may detect a pressure of the manifold 70 and provide the detected pressure to the controller 20.

Upon receiving a start on signal from a peripheral control device 30 through in-vehicle communication, the controller 20 may supply hydrogen by performing the initial driving sequence and then operating the supply valve 50.

Here, the controller 20 may perform the initial driving sequence that repeatedly turns the vessel valve 50 on and off for a first set time in an off state of the supply valve 50 and then detect a change in pressure in the manifold 70 through the pressure sensor 50. When not detecting a change to a pressure that is a predetermined pressure or higher, the controller 20 may supply hydrogen by operating the vessel valve 40 and the supply valve 50.

However, when detecting the change in pressure in the manifold 70 and detecting the change to the pressure that is the predetermined pressure or higher, the controller 20 may detect the change in pressure in the manifold 70 after repeating the initial driving sequence and operate the vessel valve 40 and the supply valve 50 to supply hydrogen.

As described above, when the pressure is balanced after performing the initial driving sequence one time at the beginning of start and thus the change to the pressure that is the predetermined pressure or higher is not detected, hydrogen is supplied by operating the vessel valve 40 and the supply valve 50.

However, when detecting the change to the pressure that is the predetermined pressure or higher, the controller 20 repeats the initial driving sequence and then re-detects a change in pressure. When not detecting the change to the pressure that is the predetermined pressure or higher, the controller 20 supplies hydrogen by operating the vessel valve 40 and the supply valve 50.

Such a repetitive performance is repeated until a second set time has elapsed after the start on signal is input, and then the controller 20 may supply hydrogen by operating the vessel valve 40 and the supply valve 50.

Then, when supply capacity is insufficient or start fails, the controller 20 may allow the peripheral control device 30 to output a warning or switch to a driving unavailability state.

Meanwhile, when hydrogen is supplied by operating the vessel valve 40 and the supply valve 50, the controller 20 may output a supply signal to the peripheral control device 30 and allow the peripheral control device 30 to perform a start on procedure.

Then, upon receiving a start off signal from the peripheral control device 30, the controller 20 may block the hydrogen supply by blocking the vessel valve 40 and the supply valve 50.

Meanwhile, the controller 20 may be an electronic control unit (ECU) for a vehicle and include a processor, a memory connected to the processor, etc.

As described above, according to the hydrogen supply device for a fuel cell vehicle according to the embodiment of the present invention, by detecting and stabilizing the change in pressure caused by the pressure difference between the vessels by performing the initial driving sequence upon starting the fuel cell vehicle and then supplies hydrogen to the fuel cell, it is possible to prevent lack of the flow rate and the pressure drop phenomenon due to the pressure difference upon starting and stably start the fuel cell vehicle.

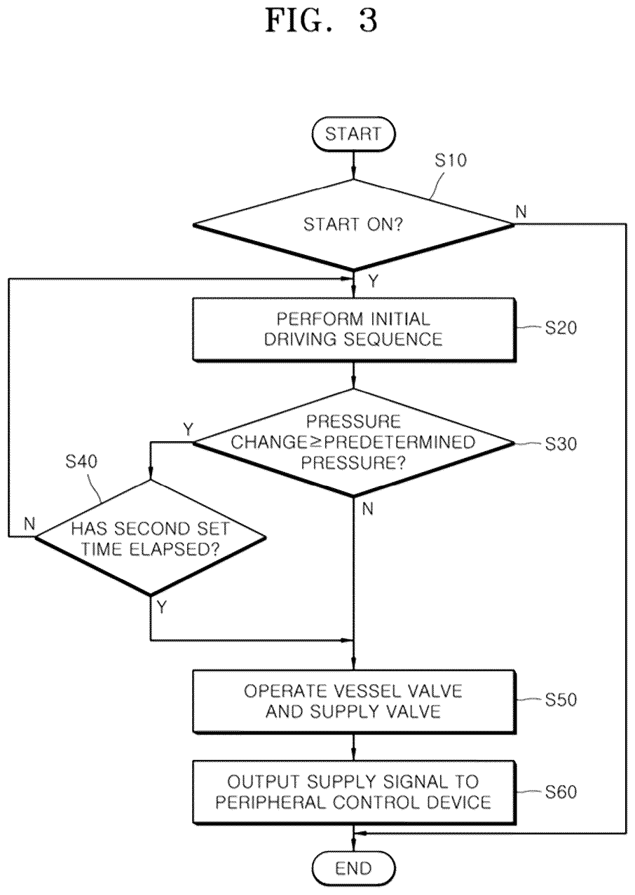

FIG. 3 is a flowchart for describing a method of controlling the hydrogen supply device for a fuel cell vehicle according to one embodiment of the present invention.

As shown in FIG. 3, the method of controlling the hydrogen supply device for a fuel cell vehicle according to the embodiment of the present invention first includes determining, by the controller 20, whether the start on signal is received from the peripheral control device 30 through in-vehicle communication (S10).

Upon receiving the start on signal in operation S10, the controller 20 performs the initial driving sequence (S20).

Here, the initial driving sequence is an operation of allowing the controller 20 to repeatedly turn the vessel valve 50 on and off for the first set time in the off state of the supply valve 50.

The pressure difference between the hydrogen vessels 60 occurring when the hydrogen supply device is not operated for a long time can be eliminated through such an initial driving sequence. In addition, the change in pressure can be quickly detected.

After performing the initial driving sequence in operation S20, the controller 20 detects a change in pressure in the manifold 70 (S30).

Here, the controller 20 may determine whether the pressure is changed to the predetermined pressure or higher.

When the pressure of the manifold 70 is detected in operation S30 and the pressure is changed to the predetermined pressure or higher, the controller 20 returns to operation S20 of performing the initial driving sequence and repeats the above process.

At this time, the controller 20 determines whether the second set time has elapsed after receiving the start on signal (S40).

When the second set time has not elapsed in operation S40, the controller 20 returns to operation S20 of performing the initial driving sequence.

Meanwhile, in operation S30, when the change in pressure in the manifold 70 is detected and the pressure is not changed to the predetermined pressure or higher, the controller 20 supplies hydrogen to the fuel cell 100 through the regulator 90 by operating the vessel valve 40 and the supply valve 50 (S50).

In addition, when it is determined that the second set time has elapsed after the start on signal is input in operation S40 and the second set time has elapsed, the controller 20 supplies hydrogen to the fuel cell 100 through the regulator 90 by operating the vessel valve 40 and the supply valve 50 (S50).

Such a repetitive performance of the initial driving sequence is repeated until the second set time has elapsed after the start on signal is input, and then the controller 20 may supply hydrogen by operating the vessel valve 40 and the supply valve 50.

Then, when supply capacity is insufficient or start fails, the controller 20 may allow the peripheral control device 30 to output a warning or switch to a driving unavailability state.

When hydrogen is supplied by operating the vessel valve 40 and the supply valve 50 in operation S50, the controller 20 outputs the supply signal to the peripheral control device 30 through in-vehicle communication and allows the peripheral control device 30 to perform the start procedure (S60).

Then, upon receiving the start off signal from the peripheral control device 30, the controller 20 blocks the hydrogen supply by blocking the vessel valve 40 and the supply valve 50.

As described above, according to the method of controlling the hydrogen supply device for a fuel cell vehicle according to the embodiment of the present invention, by detecting and stabilizing the change in pressure caused by the pressure difference between the vessels by performing the initial driving sequence upon starting the fuel cell vehicle and then supplies hydrogen to the fuel cell, it is possible to prevent lack of the flow rate and the pressure drop phenomenon due to the pressure difference upon starting and stably start the fuel cell vehicle.

The implementation described in the present specification may be implemented, for example, as a method or process, device, a software program, a data stream, or a signal.

Although the context of the implementation of a single form (e.g., only a method is described) is only described, the implementations of the described features may also be implemented in other forms (e.g., devices or programs). The device may be implemented with appropriate hardware, software, firmware, etc. The method may be implemented using a device such as a processor, which is generally referred to as a processing device including, for example, a computer, a microprocessor, an integrated circuit, a programmable logic device, etc.

The present invention has been described with reference to embodiments shown in the accompanying drawings, but it is merely illustrative, and those skilled in the art to which the relevant technology pertains will understand that various modifications and other equivalent embodiments are possible therefrom.

Therefore, the true technical scope of the present invention should be determined by the appended claims.

1. A hydrogen supply device for a fuel cell vehicle, comprising:
a vessel valve mounted on each of a plurality of hydrogen vessels to supply and block hydrogen;
a manifold connected to the plurality of hydrogen vessels through a supply pipe;
a regulator connected to the manifold to lower a high pressure of hydrogen to a pressure required for a fuel cell and supply the hydrogen of the lowered pressure;
a supply valve installed on the supply pipe between the manifold and the regulator to control hydrogen supply;
a pressure sensor configured to detect a pressure of the manifold; and
a controller configured to perform an initial driving sequence when a vehicle starts and then supply hydrogen by operating the vessel valve and the supply valve.

2. The hydrogen supply device of claim 1, wherein the controller performs the initial driving sequence that repeatedly turns the vessel valve on and off for a first set time in an off state of the supply valve.

3. The hydrogen supply device of claim 2, wherein the controller detects a change in pressure in the manifold through the pressure sensor after performing the initial driving sequence, and when not detecting a change to a pressure that is a predetermined pressure or higher, supplies hydrogen by operating the vessel valve and the supply valve.

4. The hydrogen supply device of claim 3, wherein the controller detects the change in pressure in the manifold, when detecting the change to the pressure that is the predetermined pressure or higher, detects a change in pressure in the manifold after repeating the initial driving sequence, and supplies hydrogen by operating the vessel valve and the supply valve.

5. The hydrogen supply device of claim 4, wherein, when the vehicle starts and then a second set time has elapsed, the controller supplies hydrogen by operating the vessel valve and the supply valve.

6. The hydrogen supply device of claim 1, wherein, when hydrogen is supplied by operating the vessel valve and the supply valve, the controller outputs a hydrogen supply signal to a peripheral control device.

7. A method of controlling a hydrogen supply device for a fuel cell vehicle, the method comprising:
performing, by a controller, an initial driving sequence upon receiving a start on signal from a peripheral control device;
detecting, by the controller, a change in pressure in a manifold after performing the initial driving sequence;
when the controller detects the change in pressure in the manifold and the pressure is changed to a predetermined pressure or higher, returning to the performing of the initial driving sequence; and
when the controller detects the change in pressure in the manifold and the pressure is not changed to the predetermined pressure or higher, supplying hydrogen by operating a vessel valve and a supply valve.

8. The method of claim 7, wherein the performing of the initial driving sequence includes repeatedly turning, by the controller, the vessel valve on and off for a first set time in an off state of the supply valve.

9. The method of claim 7, wherein the returning to the performing of the initial driving sequence further includes supplying, by the controller, hydrogen by operating the vessel valve and the supply valve when a second set time has elapsed after receiving the start on signal.

10. The method of claim 7, further comprising outputting, by the controller, a supply signal to the peripheral control device when hydrogen is supplied by operating the vessel valve and the supply valve.
